(19) United States
(12) Patent Application Publication
(10) Pub. No.: US 2015/0033315 A1
(43) Pub. Date: Jan. 29, 2015

(54) AUTHENTICATION AND DIAGNOSTIC FUNCTIONS FOR A DATABASE SYSTEM

(71) Applicant: salesforce.com, inc., San Francisco, CA (US)

(72) Inventors: Ashok Gadamsetty, Prakasam (IN); Santhosh Kumar Kuchoor, Hyderabad (IN)

(73) Assignee: salesforce.com, inc., San Francisco, CA (US)

(21) Appl. No.: 14/035,141

(22) Filed: Sep. 24, 2013

Related U.S. Application Data
(60) Provisional application No. 61/857,622, filed on Jul. 23, 2013.
(60) Provisional application No. 61/857,477, filed on Jul. 23, 2013.

(51) Int. Cl. H04L 29/06; G06F 11/36

(52) U.S. Cl. CPC H04L 63/0815; G06F 11/3676
USPC 726/8; 717/124

(57) ABSTRACT

A computer system and related features and functionality are presented here. The computer system may be implemented as a multi-tenant database system that supports a number of users via web browser interfaces. The system supports a user authentication method that maintains access tokens at a local client device level for purposes of single sign-on to different tenants or to different native local applications. The system also supports a method of testing computer executable code. The testing procedure defines and tests a plurality of different browser-based functions, and generates a consolidated code coverage report that includes the results of the tests.

### CROSS-REFERENCE TO RELATED APPLICATIONS

This application claims the benefit of: U.S. provisional patent application No. 61/857,622, filed Jul. 23, 2013 (titled AUTHENTICATION AND DIAGNOSTIC FUNCTIONS FOR A DATABASE SYSTEM: SINGLE SIGN-ON USING LOCAL CLIENT APPLICATION); and U.S. provisional application No. 61/857,477, filed Jul. 23, 2013 (titled AUTHENTICATION AND DIAGNOSTIC FUNCTIONS FOR A DATABASE SYSTEM: SIMPLIFIED TECHNIQUE FOR CODE COVERAGE TESTING).

### TECHNICAL FIELD

Embodiments of the subject matter described herein relate generally to computer systems. More particularly, embodiments of the subject matter relate to diagnostic and authentication techniques suitable for use in a multi-tenant database system.

### BACKGROUND

Modern software development is evolving away from the client-server model toward network-based processing systems that provide access to data and services via the Internet or other networks. In contrast to traditional systems that host networked applications on dedicated server hardware, a cloud computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Most cloud-based applications are implemented for use with Internet browsers running on client devices. Consequently, such cloud-based applications are susceptible to response time delays, loading effects, and other factors that might impact the end user experience. For this reason, cloud-based applications can be subjected to performance testing to determine response times under various simulated loading conditions and to check whether stated service level agreement requirements are satisfied. For example, the SELENIUM suite of software can be used to test the performance of web applications.

A multi-tenant database system may be designed to support various single sign-on (SSO) techniques and technologies that allow a user of the system to seamlessly log into different services, organizations, applications, and/or accounts (referred to herein as “entities”) using only one set of authentication credentials. A web-based system may also utilize SSO techniques to enable a user to seamlessly log into multiple entities by manipulating a web browser to enter one set of credentials.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 illustrates a block diagram of an exemplary embodiment of an on-demand database system environment;

FIG. 2 illustrates a block diagram of an exemplary embodiment of a multi-tenant database system environment;

FIG. 3 is a flow chart that illustrates an exemplary embodiment of a local client based single sign-on process;

FIG. 4 is a flow chart that illustrates an exemplary embodiment of a code testing process;

FIG. 5 depicts an exemplary summary screen of a consolidated test report; and

FIG. 6 depicts an exemplary source screen of a consolidated test report.

### DETAILED DESCRIPTION

The subject matter presented here relates to a variety of features and operations performed by or otherwise utilized with a database system. In particular, techniques and functionality related to user authentication and software diagnostics are provided in the context of a multi-tenant database system. Although exemplary embodiments are described with reference to a multi-tenant database environment, it should be appreciated that the subject matter need not be restricted to such an implementation.

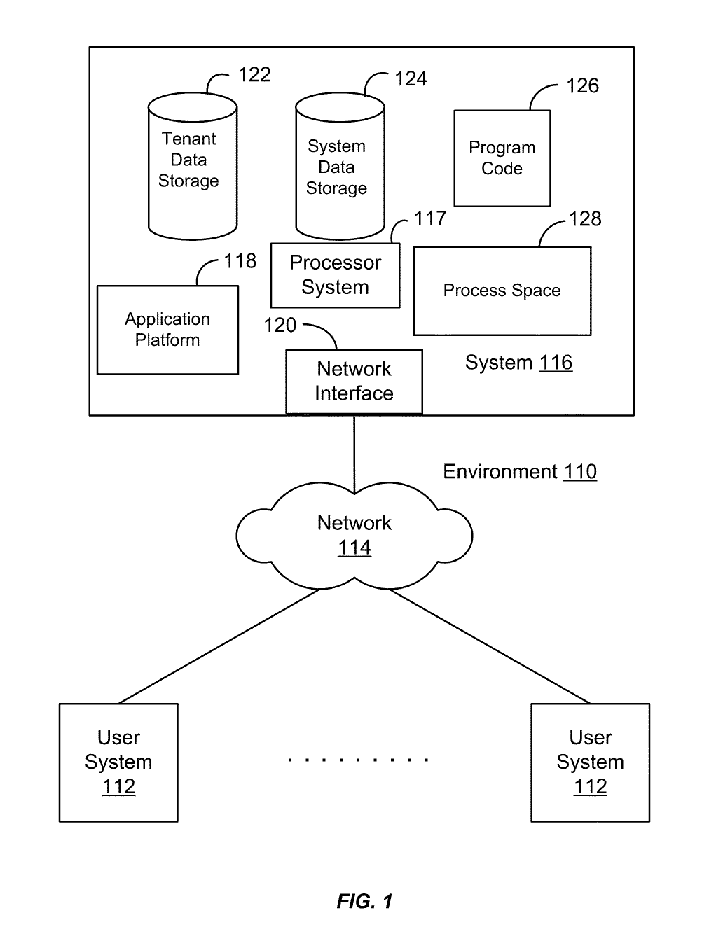

FIG. 1 illustrates a block diagram of an environment 110 suitable for use with an on-demand database service. Environment 110 may include user systems 112, network 114, system 116, processor system 117, application platform 118, network interface 120, tenant data storage 122, system data storage 124, program code 126, and process space 128. In other embodiments, environment 110 may not have all of the components listed and/or may have other elements instead of, or in addition to, those listed above.

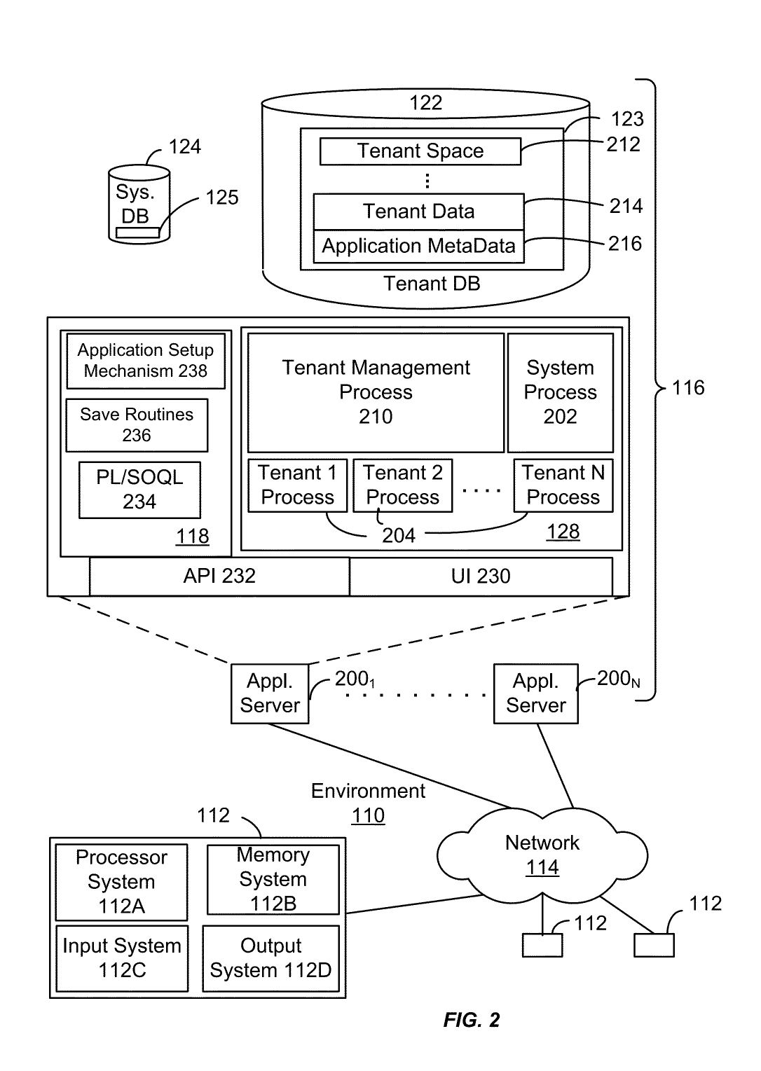

Environment 110 is an environment in which an on-demand database service exists. User system 112 may be any machine or system that is used by a user to access a database user system. For example, any of user systems 112 can be a handheld computing device, a mobile phone, a laptop computer, a work station, and/or a network of computing devices. As illustrated in FIG. 1 (and in more detail in FIG. 2) user systems 112 might interact via a network 114 with an on-demand database service, which is system 116.

An on-demand database service, such as system 116, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 116” and “system 116” will be used interchangeably herein. A database image may include one or more database objects. A relational database management system (RDMS) or the equivalent may execute storage and retrieval of information against the database object(s). Application platform 118 may be a framework that allows the applications of system 116 to run, such as the hardware and/or software, e.g., the operating system. In an embodiment, on-demand database service 116 may include an application platform 118 that enables creation, managing and executing one or more applications developed by the provider of the on-demand database service, users accessing the on-demand database service via user systems 112, or third party application developers accessing the on-demand database service via user systems 112.

The users of user systems 112 may differ in their respective capacities, and the capacity of a particular user system 112 might be entirely determined by permissions (permission levels) for the current user. For example, where a salesperson is using a particular user system 112 to interact with system 116, that user system has the capacities allotted to that salesperson. However, while an administrator is using that user system to interact with system 116, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 114 is any network or combination of networks of devices that communicate with one another. For example, network 114 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 112 might communicate with system 116 using TCP/IP and, at a higher network level, use other common Internet protocols to communicate, such as HTTP, FTP, AFS, WAP, etc. In an example where HTTP is used, user system 112 might include an HTTP client commonly referred to as a “browser” for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 116, shown in FIG. 1, implements a web-based customer relationship management (CRM) system. For example, in one embodiment, system 116 includes application servers configured to implement and execute CRM software applications as well as provide related data, code, forms, webpages and other information to and from user systems 112 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 116 implements applications other than, or in addition to, a CRM application. For example, system 116 may provide tenant access to multiple hosted (standard and custom) applications, including a CRM application, an information networking application (which may be a social networking application or an enterprise networking application), or the like. User (or third party developer) applications, which may or may not include CRM, may be supported by the application platform 118, which manages creation, storage of the applications into one or more database objects and executing of the applications in a virtual machine in the process space of the system 116.

One arrangement for elements of system 116 is shown in FIG. 1, including a network interface 120, application platform 118, tenant data storage 122 for tenant data 123, system data storage 124 for system data 125 accessible to system 116 and possibly multiple tenants, program code 126 for implementing various functions of system 116, and a process space 128 for executing MTS system processes and tenant-specific processes, such as running applications as part of an application hosting service. Additional processes that may execute on system 116 include database indexing processes, information networking processes, user authentication and single sign-on processes, and the like.

Several elements in the system shown in FIG. 1 include conventional, well-known elements that are explained only briefly here. For example, each user system 112 could include a desktop personal computer, workstation, laptop, PDA, cell phone, or any wireless access protocol (WAP) enabled device or any other computing device capable of interfacing directly or indirectly to the Internet or other network connection. User system 112 typically runs an HTTP client, e.g., a browsing program, such as Microsoft's Internet Explorer browser, Google's Chrome browser, Mozilla's Firefox browser, Apple's Safari browser, Netscape's Navigator browser, Opera's browser, or a WAP-enabled browser in the case of a cell phone, smartphone, PDA or other wireless device, or the like, allowing a user (e.g., subscriber of the multi-tenant database system) of user system 112 to access, process and view information, pages and applications available to it from system 116 over network 114. Each user system 112 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 116 or other systems or servers. For example, the user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 112 and all of its components are operator configurable using applications, such as a browser, including computer code run using a central processing unit such as an Intel Pentium® processor or the like. Similarly, system 116 (and additional instances of an MTS, where more than one is present) and all of their components might be operator configurable using application(s) including computer code to run using a central processing unit such as processor system 117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Oracle America, Inc.).

According to one embodiment, each system 116 is configured to provide webpages, forms, applications, data and media content to user (client) systems 112 to support the access by user systems 112 as tenants of system 116. As such, system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 110. However, in FIG. 2 elements of system 116 and various interconnections in an embodiment are further illustrated. FIG. 2 shows that user system 112 may include processor system 112A, memory system 112B, input system 112C, and output system 112D. FIG. 2 shows network 114 and system 116. FIG. 2 also shows that system 116 may include tenant data storage 122, tenant data 123, system data storage 124, system data 125, User Interface (UI) 230, Application Program Interface (API) 232, PL/SOQL 234, save routines 236, application setup mechanism 238, applications servers 200₁-200_{N}, system process space 202, tenant process spaces 204, tenant management process space 210, tenant storage area 212, user storage 214, and application metadata 216. In other embodiments, environment 110 may not have the same elements as those listed above and/or may have other elements instead of, or in addition to, those listed above.

User system 112, network 114, system 116, tenant data storage 122, and system data storage 124 were discussed above with reference to FIG. 1. Regarding user system 112, processor system 112A may be any combination of one or more processors. Memory system 112B may be any combination of one or more memory devices, short term, and/or long term memory. Input system 112C may be any combination of input devices, such as one or more keyboards, mice, trackballs, scanners, cameras, and/or interfaces to networks. Output system 112D may be any combination of output devices, such as one or more monitors, printers, and/or interfaces to networks. As shown by FIG. 2, system 116 may include a network interface 120 (of FIG. 1) implemented as a set of HTTP application servers 200, an application platform 118, tenant data storage 122, and system data storage 124. Also shown is system process space 202, including individual tenant process spaces 204 and a tenant management process space 210. Each application server 200 may be configured to tenant data storage 122 and the tenant data 123 therein, and system data storage 124 and the system data 125 therein to serve requests of user systems 112. The tenant data 123 might be divided into individual tenant storage areas 212, which can be either a physical arrangement and/or a logical arrangement of data. Within each tenant storage area 212, user storage 214 and application metadata 216 might be similarly allocated for each user. For example, a copy of a user's most recently used (MRU) items might be stored to user storage 214. Similarly, a copy of MRU items for an entire organization that is a tenant might be stored to tenant storage area 212. A UI 230 provides a user interface and an API 232 provides an application programmer interface to system 116 resident processes to users and/or developers at user systems 112. The tenant data and the system data may be stored in various databases, such as one or more Oracle™ databases.

Application platform 118 includes an application setup mechanism 238 that supports application developers' creation and management of applications, which may be saved as metadata into tenant data storage 122 by save routines 236 for execution by subscribers as one or more tenant process spaces 204 managed by tenant management process 210 for example. Invocations to such applications may be coded using PL/SOQL 34 that provides a programming language style interface extension to API 932. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving application metadata 216 for the subscriber making the invocation and executing the metadata as an application in a virtual machine.

Each application server 200 may be communicably coupled to database systems, e.g., having access to system data 125 and tenant data 123, via a different network connection. For example, one application server 200₁ might be coupled via the network 114 (e.g., the Internet), another application server 200_{N}-₁ might be coupled via a direct network link, and another application server 200_{N} might be coupled by yet a different network connection. Transfer Control Protocol and Internet Protocol (TCP/IP) are typical protocols for communicating between application servers 200 and the database system. However, it will be apparent to one skilled in the art that other transport protocols may be used to optimize the system depending on the network interconnect used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, therefore, an interface system implementing a load balancing function (e.g., an F5 Big-IP load balancer) is communicably coupled between the application servers 200 and the user systems 112 to distribute requests to the application servers 200. In one embodiment, the load balancer uses a least connections algorithm to route user requests to the application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, system 116 is multi-tenant, wherein system 116 handles storage of, and access to, different objects, data and applications across disparate users and organizations.

As an example of storage, one tenant might be a company that employs a sales force where each salesperson uses system 116 to manage their sales process. Thus, a user might maintain contact data, leads data, customer follow-up data, performance data, goals and progress data, etc., all applicable to that user's personal sales process (e.g., in tenant data storage 122). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 116 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 116 might also maintain system level data usable by multiple tenants or other data. Such system level data might include industry reports, news, postings, and the like that are sharable among tenants.

In certain embodiments, user systems 112 (which may be client systems) communicate with application servers 200 to request and update system-level and tenant-level data from system 116 that may require sending one or more queries to tenant data storage 122 and/or system data storage 124. System 116 (e.g., an application server 200 in system 116) automatically generates one or more SQL statements (e.g., one or more SQL queries) that are designed to access the desired information. System data storage 124 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Single Sign-On Using Local Client Application

A database system of the type described herein may be suitably configured as a multi-tenant database system that supports a plurality of different tenants (also referred to herein as “organizations”). One end user may be a member of different tenants supported by the multi-tenant database system. In a typical operating scenario, an end user accesses different instantiations of the multi-tenant database system as needed to interact with the different tenants. Accordingly, one end user may be issued multiple sets of login credentials for purposes of authentication when attempting to access resources of the different tenants.

Single sign-on (SSO) techniques have been developed to enable a user to seamlessly log into multiple resources using only one set of login credentials. As an example, assume that a user is a member of a web-based email service provided by a first entity, a member of a social networking site provided by a second entity, and a member of a web-based shopping site provided by a third entity. An SSO protocol would allow that user to log into all three services by entering only one set of credentials, e.g., the login information for the web-based email service.

The subject matter presented here relates to a client-side SSO approach that enables a local native client application to perform an SSO routine as needed to access tenant resources maintained by a multi-tenant database system. In certain embodiments, the native client application provides local, stand-alone, and non-browser based support of an information networking environment that involves a plurality of different tenants of a multi-tenant database system. In this regard, the native client application emulates at least some of the features and functionality provided by a browser-based information networking environment, e.g., a web-based social network application, a web-based enterprise or business networking environment, or the like. Although the native client application still utilizes some form of network communication to cooperate with certain server-side features, and to access networked multi-tenant database architectures, it need not rely on a web browser application. The native client application utilizes SSO technology to enable the user to seamlessly access different tenants (as needed) without having to enter different login data, and without having to switch back and forth between multiple instantiations that correspond to the different tenant environments.

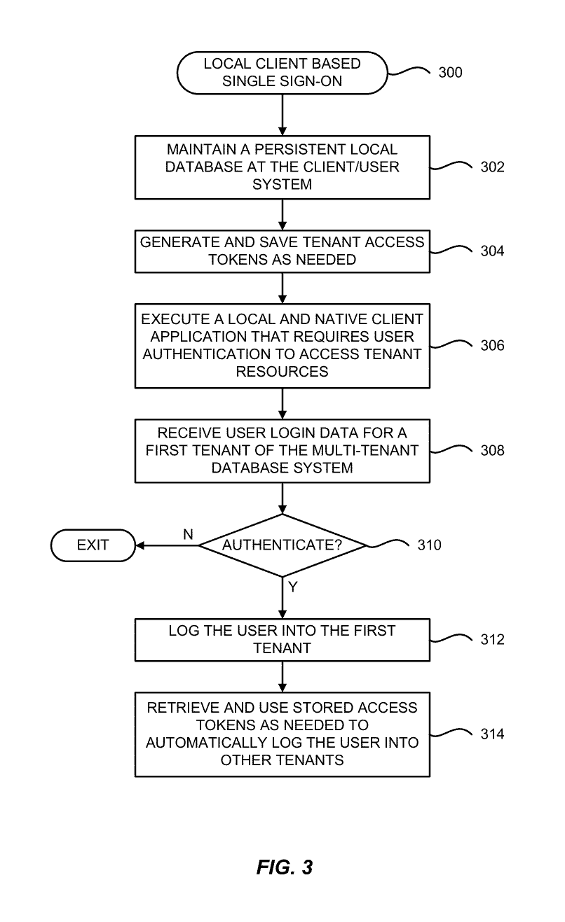

FIG. 3 is a flow chart that illustrates an exemplary embodiment of a local client based single sign-on process 300. The process 300 may be performed by a user system (e.g., a client computing device) in cooperation with a multi-tenant database system of the type described herein. The process 300 creates and maintains a persistent local database at the user system (task 302) for purposes of supporting the SSO feature. This database is persistent in that certain authentication-related information is stored in a persistent manner from session to session, and across boot-up and power-on cycles of the host device. In certain embodiments, the local database stores a plurality of different access tokens that facilitate SSO to a plurality of different tenants of the multi-tenant database system. Accordingly, the process 300 may operate to generate and save the access tokens in the persistent database as needed (task 304). For example, the process 300 may obtain login data (username and password) for each of the different tenants, and then generate the corresponding access tokens in response to obtaining the login data. A given access token could be created, retrieved from a pool of available tokens, or the like. A given access token may be generated and stored in the persistent database at any time, e.g., during a configuration routine, or on the fly whenever the corresponding login data is entered by the user for the first time.

This example assumes that the process 300 has already stored all of the relevant access tokens in the persistent database. This example also assumes that the user system is operated to execute a native client application that provides stand-alone and non-browser based support of an information networking environment that involves, cooperates with, requests resources from, or otherwise utilizes the plurality of different tenants of the multi-tenant database system (task 306). Notably, accessing the tenant resources requires user authentication. Accordingly, the native client application receives or processes user login data for a first tenant supported by the multi-tenant database system (task 308). The received login data is processed by an authentication engine or module of the user system to determine whether or not the proper credentials have been entered (query task 310).

This example assumes that the received login data is effective to authenticate the user, relative to the first tenant (the “Yes” branch of query task 310). Accordingly, the process 300 continues by logging the user into the first tenant (task 312). Moreover, the process 300 automatically and seamlessly logs the user into at least one additional tenant (task 314). Notably, the process 300 retrieves and uses the stored access tokens to automatically log the user into the other tenant(s) in a manner that is transparent to the end user. In other words, task 314 performs SSO in response to the entry of only one set of user credentials, and logs the user into at least one other tenant without prompting the user to enter any additional login data. Thereafter, the native client application can access information, data, and resources associated with a plurality of different tenants, and take appropriate action at the local client system level as needed.

The local user system may also be configured to support a similar SSO approach in the context of a plurality of different native applications that execute locally on the user system. In this regard, the persistent database can be utilized to store access tokens and/or other authentication information for a plurality of different local applications. The saved access tokens can then be used as needed to seamlessly authenticate the user in connection with the use or execution of the different native applications, as long as the user successfully logs into any one of those applications. This technique allows the user to launch and use a plurality of different native client applications without having to repeatedly enter the respective login data for each application.

Simplified Technique for Code Coverage Testing

A database system of the type described herein may be suitably configured to support software development, diagnostic, and testing tools. In certain embodiments, a database system of the type described herein provides web browser based services, features, and functions to its users, tenants, and organizations. Accordingly, it may be desirable to have a reliable and convenient software testing framework for web-based applications. In this regard, the SELENIUM software testing framework can be utilized to test certain browser-based functionality if so desired.

Conventional software testing tools provide code coverage tests for actions performed on a web page. However, the corresponding test reports are lost when the web browser is closed and reopened. Accordingly, such conventional tools are inconvenient and inefficient, especially if a developer needs to test a large number of browser-based features while opening and closing the testing web browser application. To address this problem, the code testing architecture described here utilizes a suitably configured API to obtain the code coverage results for a plurality of browser-based test cases. The API is designed such that it can be easily incorporated into any existing framework with little to no customization or modification to the existing framework.

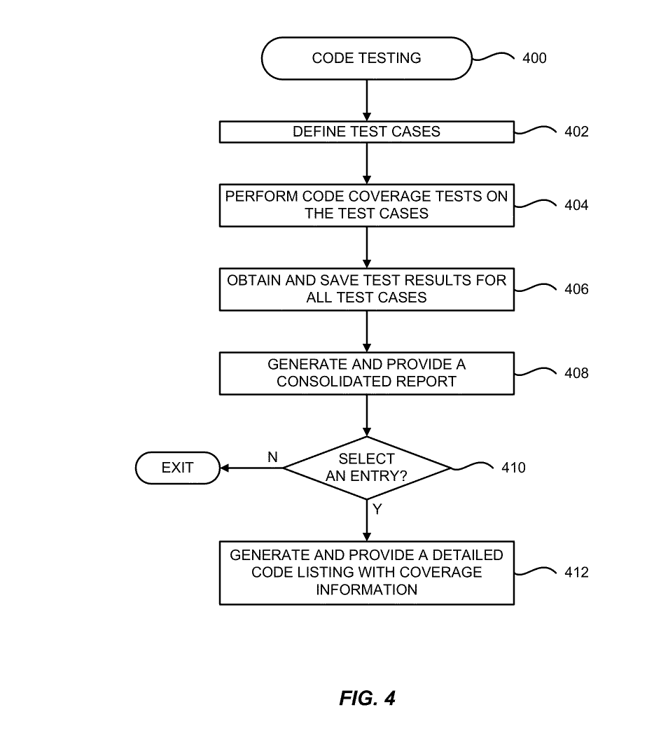

FIG. 4 is a flow chart that illustrates an exemplary embodiment of a code testing process 400. The process 400 may be performed by a user system (e.g., a client computing device) in cooperation with a multi-tenant database system of the type described herein. The process 300 allows the user to test computer executable code that is intended to provide certain browser-based functions. As used here, a “browser-based function” may be any feature, operation, procedure, method, process, or routine that is initiated, supervised, managed, or executed by a web browser application. The process 400 can be used to test any number of such browser-based functions. For example, one function to be tested may relate to a user login operation. Another function to be tested may relate to a request to retrieve and play a video clip. Another function to be tested may relate to a user registration procedure. These and other examples are contemplated by this description.

The process 400 defines, obtains, or otherwise designates a plurality of test cases (task 402). Each test case corresponds to a different browser-based function that is carried out by computer executable code. In certain scenarios, the computer executable code includes a plurality of scripts, e.g., scripts written in the JAVA programming language. The process 400 performs code coverage tests on each of the test cases (task 404), and obtains and saves the corresponding test results (task 406). The executable code that is responsible for each browser-based function is subjected to a code coverage test to determine which portion of the code is actually executed and which portion of the code is not executed. In accordance with conventional code coverage nomenclature, 100% coverage means that all of the code written for a designated function is executed to actually carry out that function (this is an ideal scenario). On the other hand, 50% coverage means that only half of the written code is actually executed (this indicates an inefficient use of code). The process 400 may leverage any existing or available code coverage application or software, such as the SELENIUM testing framework.

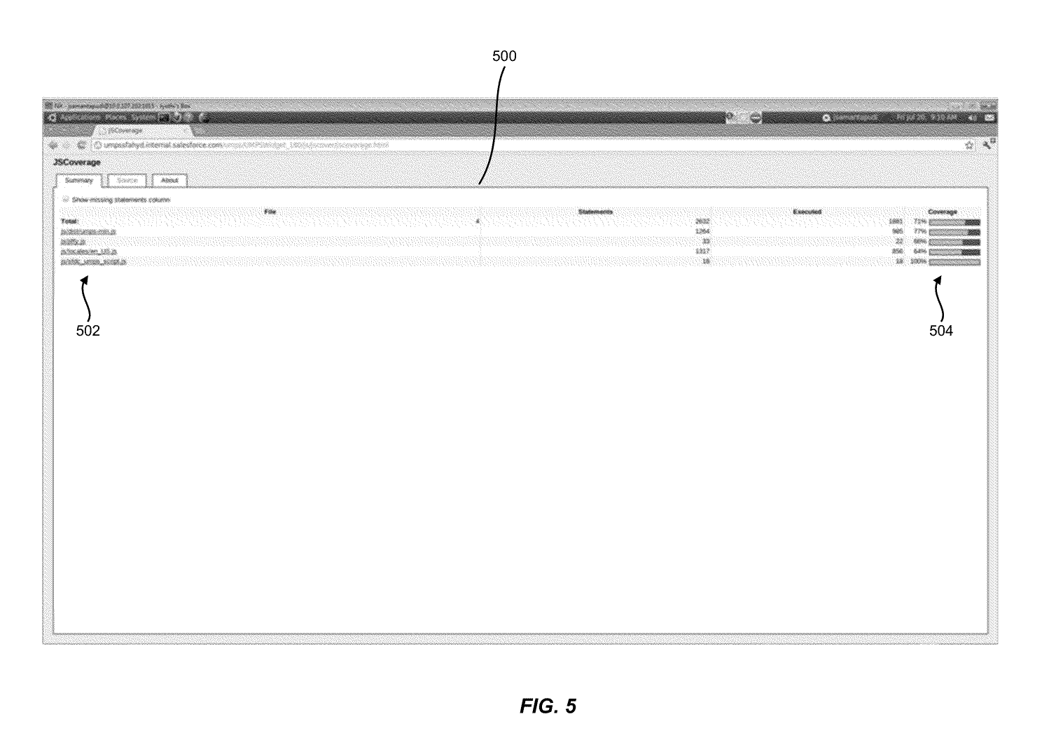

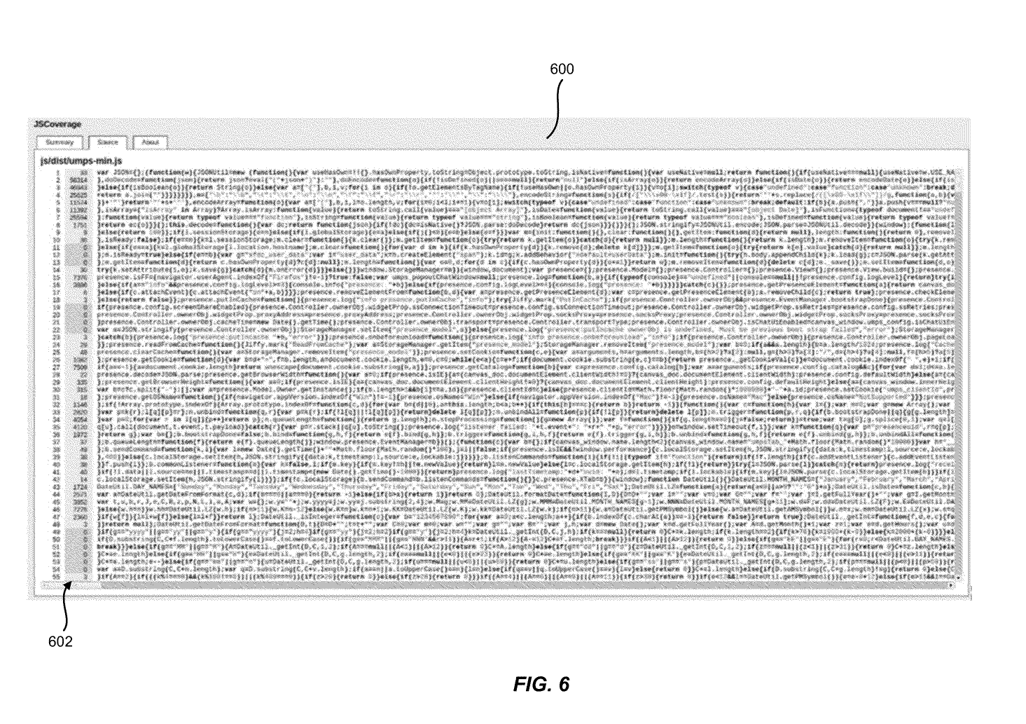

The process 400 generates and provides a consolidated report (task 408) that includes the test results for the different test cases. In this regard, FIG. 5 depicts an exemplary summary screen 500 of a consolidated test report. For this particular example, the summary screen 500 includes five entries 502 corresponding to five test cases. The summary screen 500 includes coverage information 504 for each test case. The coverage information 504 may include a percentage value that represents the coverage score. The coverage information 504 may also include a graphical depiction of the coverage score, in the form of a color-coded bar in this example. Each entry 502 is rendered as a selectable item on the summary screen 500. In response to the selection of an entry 502, the user interface is updated to provide additional information related to the selected entry 502. In this context, FIG. 6 depicts an exemplary source screen 600 of a consolidated test report. The source screen 600 is generated when an entry 502 is selected. The source screen 600 includes a listing of the executable code (in a line-by-line format), along with indicia 602 of code coverage. For this example, the indicia is color-coded such that green indicates executed lines of code and red indicates unexecuted lines of code.

Notably, process 400 can be utilized to perform code coverage tests on any number of test cases, whether or not the associated web browser application remains open or is closed between test cases. For example, a first code coverage test can be performed for a first test case, and the resulting code coverage results can be saved before closing the web browser application that is used to perform the first test case. Thereafter, the web browser application can be re-opened to perform a second code coverage test on a second test case. This routine can be repeated any number of times, while saving and maintaining the test results between each individual test. Notably, the test results are saved and preserved for purposes of reporting regardless of how many times the web browser application is opened and closed. Eventually, the process 400 can generate and display the consolidated report to provide all of the test results to the user in a convenient manner.

In accordance with some exemplary embodiments, the process 400 is realized in the following manner. The underlying code for a test case is obtained as an input (the underlying code represents the code that is executed to perform the browser-based function under test). The underlying code is processed to create an archive file that includes the underlying code and additional information such as metadata that is used to perform the testing. The underlying code may include or call for scripts that are normally maintained at a server, e.g., scripts written in the JAVA programming language. Accordingly, the archive file could be formatted as a JAVA archive file (a “jar” file).

Code associated with the scripts may be retrieved from a server or otherwise obtained in association with the archive file. Thereafter, the archive file and the script code (if any) are subjected to the code coverage tests using an appropriate testing suite, e.g., the SELENIUM software testing suite. The results of the code coverage tests are provided to a suitably configured API, which in turn generates the consolidated code coverage report as described above. Notably, the testing system is designed to run on a local client machine for speed and efficiency. Accordingly, the system obtains the underlying code and the script code at the local level, and the code coverage tests are performed at the local level. This allows a user of the client machine to define and run any number of test cases, obtain the corresponding test results, and view a consolidated report of the test results at a convenient time.

Conclusion and Clarifications

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like. The code segments may be downloaded via computer networks such as the Internet, an intranet, a LAN, or the like.

The various tasks performed in connection with a process described herein may be performed by software, hardware, firmware, or any combination thereof It should be appreciated that a process described herein may include any number of additional or alternative tasks, the tasks shown in a figure need not be performed in the illustrated order, and a described process may be incorporated into a more comprehensive procedure or process having additional functionality not described in detail herein. Moreover, one or more of the tasks shown in a figure could be omitted from an embodiment of the illustrated process as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A user authentication method comprising:
maintaining, at a user system, a first access token that facilitates single sign-on to a first native client application of the user system;
receiving, at the user system, login data for a second native client application of the user system;
processing the received login data with an authentication engine of the user system;
logging the user into the second native client application when the processing authenticates the user; and
automatically logging the user into the first native client application when the processing authenticates the user, wherein the first access token is used to automatically log the user into the first native client application.

2. The method of claim 1, further comprising:
creating a second access token in response to processing the received login data, the second access token facilitating single sign-on to the second native client application; and
saving the second access token in a persistent database of the user system.

3. The method of claim 2, wherein the first access token is saved in the persistent database of the user system.

4. The method of claim 1, wherein the method is performed by a processor executing instructions of a tangible and non-transitory computer readable medium.

5. A user authentication method comprising:
maintaining, at a user system, a persistent database storing a plurality of different access tokens that facilitate single sign-on to a plurality of different tenants of a multi-tenant database system;
executing a native client application at the user system, the native client application providing stand-alone and non-browser based support of an information networking environment that involves the plurality of different tenants of the multi-tenant database system;
receiving, with the native client application at the user system, login data for a first tenant of the plurality of tenants;
processing the received login data with an authentication engine of the user system;
logging the user into the first tenant when the processing results in authentication of the user; and
automatically logging the user into at least one additional tenant of the plurality of tenants, using at least one of the access tokens stored in the persistent database.

6. The method of claim 5, further comprising:
obtaining, from the user of the user system, respective login data for each of the plurality of tenants;
generating the plurality of access tokens in response to obtaining the respective login data; and
saving the plurality of access tokens in the persistent database.

7. The method of claim 5, wherein the native client application is a local version of a web-based information networking application.

8. The method of claim 5, wherein the method is performed by a processor executing instructions of a tangible and non-transitory computer readable medium.

9. A method of testing computer executable code, the method comprising:
defining a plurality of test cases, each corresponding to a different browser-based function carried out by computer executable code;
performing code coverage tests on each of the plurality of test cases by emulating the different browser-based functions;
obtaining test results for the plurality of test cases, in response to performing the code coverage tests; and
providing a consolidated report that includes the test results for the plurality of test cases.

10. The method of claim 9, wherein the consolidated report comprises selectable entries for the test results.

11. The method of claim 9, wherein performing code coverage tests comprises:
opening a web browser application;
performing a first code coverage test on a first test case of the plurality of test cases;
saving results of the first code coverage test;
closing the web browser application;
re-opening the web browser application;
performing a second code coverage test on a second test case of the plurality of test cases; and
saving results of the second code coverage test;
wherein the obtaining step obtains the saved results of the first code coverage test and the saved results of the second code coverage test.

12. The method of claim 9, wherein the computer executable code comprises a plurality of scripts.

13. The method of claim 9, wherein the method is performed by a processor executing instructions of a tangible and non-transitory computer readable medium.
